(19) United States
(12) Patent Application Publication
(10) Pub. No.: US 2008/0235461 A1
(43) Pub. Date: Sep. 25, 2008

(54) Technique and apparatus for combining partial write transactions

(76) Inventors: Sin Tan, Portland, OR (US); Kai Cheng, Portland, OR (US); Rajesh S. Pamujula, Hillsboro, OR (US); Sivakumar Radhakrishnan, Portland, OR (US); Dhananjay Joshi, Beaverton, OR (US)

Correspondence Address: TROP PRUNER & HU, PC, 1616 S. VOSS ROAD, SUITE 750, HOUSTON, TX, 77057-2631, US

(21) Appl. No.: 11/726,563

(22) Filed: Mar. 22, 2007

(51) Int. Cl. G06F 13/28

(52) U.S. Cl. 711/146

(57) ABSTRACT

A bridge includes a memory to establish a transaction table and write combining windows. Each write combining window is associated with a cache line and is subdivided into subwindows; and each of the subwindows is associated with a partial cache line. The bridge includes a controller to determine whether an incoming partial write transaction conflicts with a transaction stored in the transaction table. If a conflict occurs, the controller uses the write combining windows to combine the partial write transaction with another partial write transaction if one of the partial write combining windows is available. The controller issues a retry signal to a processor originating the partial write transaction if none of the partial write combining windows are available.

### BACKGROUND

The invention generally relates to a technique and apparatus for combining partial write transactions.

For purposes of facilitating processing, such as graphics processing, a microprocessor may have write combining buffers. Write combining buffers may present various challenges. For example, write transactions to the write combining memory region may compete with other cacheable write transactions. Furthermore, such factors as serializing instructions, weak ordering, interrupts, context switches and entry into power saving modes may frequently evict the write combining buffers before they are full. Premature eviction happens before all write transactions to a write combining buffer are completed, resulting in a series of, for example, eight byte partial bus transactions rather than a single sixty-four byte write transaction. When partial write transactions occur on the bus, the effective rate at which data is communicated to system memory is significantly reduced. Therefore, avoiding partial-write transactions may be quite important to ensure full bus bandwidth utilization.

In conventional multi-bus server systems, it is possible for multiple processors to issue conflicting requests to the same cache-line. The chipsets in these systems typically rely on address matching to prevent the concurrent servicing of multiple conflicting transactions in order to maintain cache coherency. Subsequent conflicting transactions may be processed only after the initial transaction is completed by, for example, retrying the subsequent conflicting transactions or queuing up the transactions in a finite queue structure. A disadvantage of the retry serialization is that valuable processor request bandwidth may be wasted. The queue structure has its limitations once it gets full.

Thus, there is a continuing need for better ways to handle partial write transactions.

### BRIEF DESCRIPTION OF THE DRAWING

FIG. 1 is a schematic diagram of a system according to an embodiment of the invention.

FIG. 2 is a schematic diagram of write combining hardware of a north bridge of the system of FIG. 1 according to an embodiment of the invention.

FIG. 3 is a flow diagram depicting a technique to process partial write transactions according to an embodiment of the invention.

### DETAILED DESCRIPTION

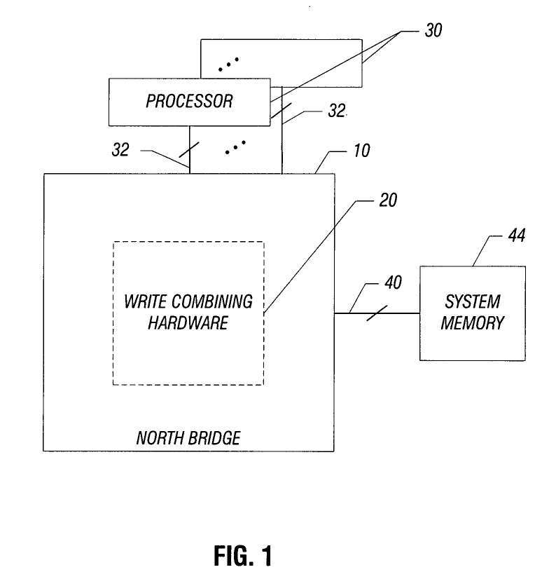

Referring to FIG. 1, in accordance with an embodiment of the invention, a bridge 10 includes write combining hardware 20 for purposes of combining partial write transactions that may be generated by multiple processors 30. The bridge 10 may include, for example, a north bridge of a computer chipset having a north bridge and a south bridge, although embodiments are not limited in this respect. As described herein, the write combining hardware 20 combines partial write transactions in a manner that reduces the possibility of conflict serialization and at the same time provide increased front side bus and memory performance. Partial write transactions include write transactions in which the data written is less than a cache line. For purposes of example, the north bridge 10 may be part of a multi-processor system, which includes (in this example) two microprocessors, or processors 30, which are coupled to the north bridge 10 via respective front side buses 32. However, the system may include more than two processors, in accordance with other embodiments of the invention. Furthermore, one or more processors 30 may be a processing core of a multiple core microprocessor package.

In general, the north bridge 10 receives write transactions from the processors 30, which may include partial write transactions, i.e., write transactions in which the data written is less than a cache line. As described further below, the write combining hardware 20 combines the partial write transactions to preferably form full cache line, or full write, transactions, which are communicated over a memory bus 40 for purposes of storing the associated data in a memory, such as in an exemplary system memory 44.

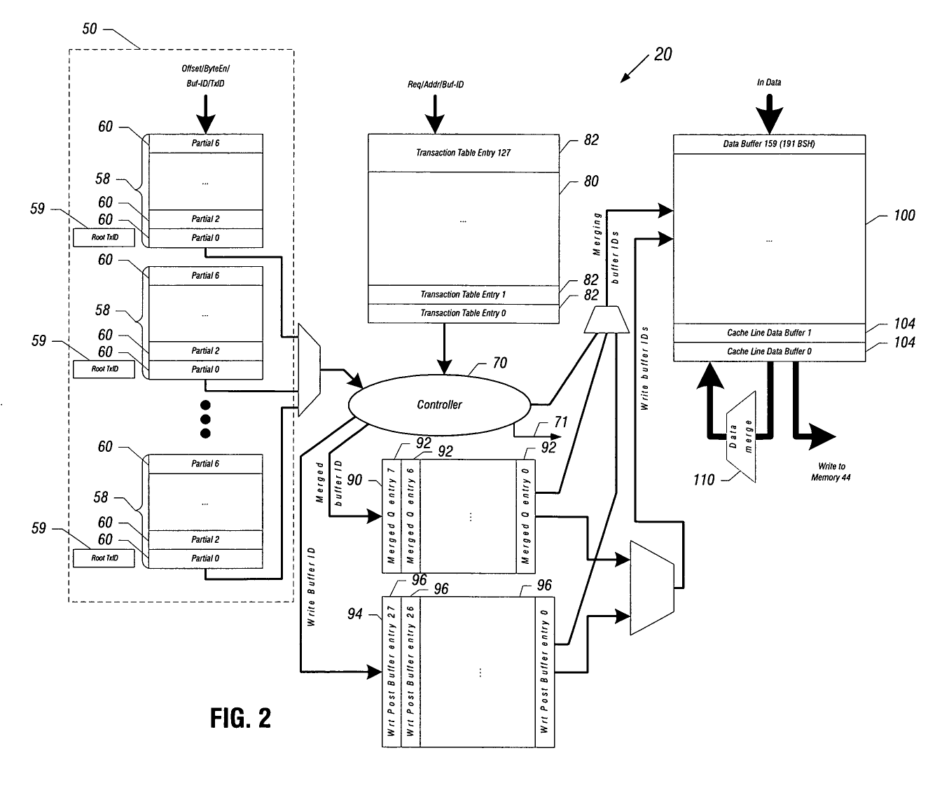

Referring to FIG. 2, in accordance with some embodiments of the invention, the write combining hardware 20 includes memory 50 that includes N write combining windows 58. Each window 58, in turn, may be subdivided into M partial sub-windows 60 for tracking and coalescing the partial cache lines. As depicted in FIG. 2 by way of example, in some embodiments of the invention, each write combining window 58 may include seven sub-windows 60, although each write combining window 58 may contain fewer or more sub-windows 60 in other embodiments of the invention.

In general, each sub-window 60 is associated with a tracking register to track the partial write segments, or “chunks,” which are stored in corresponding entries 104 of a data buffer 100. The tracking registers store such information as the address, buffer identification and other transactional-related information. As depicted in FIG. 2, each write combining window 60 may also be associated with a root transaction identification register 59 to link the initial partial write transactions recorded in a transaction table 80 with the subsequent incoming partial write transactions.

The write combining hardware 20 includes a partial merge write queue 90, which stores the partial data entries 92 to be preferably merged into full cache lines. The merged partial write data remains in the queue 90 until either an explicit flush is issued to the bridge 10 (FIG. 1) or the queue 90 is full and a new partial write transaction is enqueued.

In general, a controller 70 of the write combining hardware 20 is designed to back-fill the remainder of a partial cache line before the actual write is transacted. In certain systems, the full cache line may be modified in other processor caches. The controller 70 resolves the coherency and provides the coherent cache line for the partial merge.

The write combining hardware 20 includes a write post buffer 94, which stores posted transaction entries 96 to be written to memory. In general, the controller 70 uses the merged buffer queue 90 and the write post buffer 94 to control the merging of the partial data in the buffer 100 (via a data merge circuit 110) in order to preferably form full cache line writes to the memory.

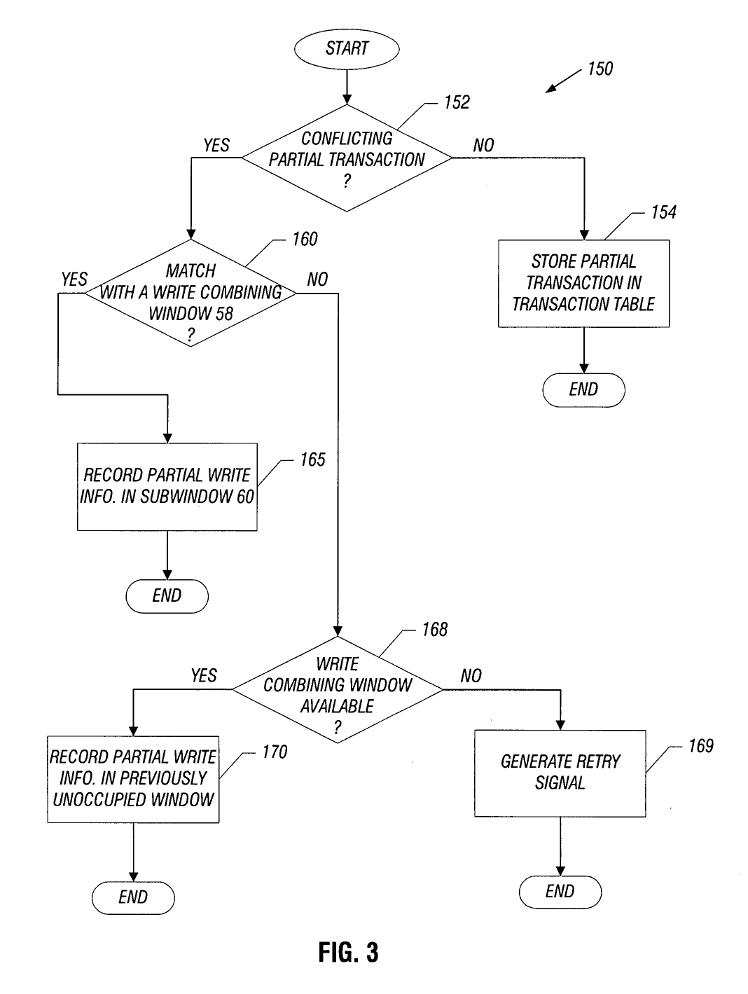

The write combining hardware 20 also includes a transaction table 80, which has entries 82 to track the accepted write transactions. In general, partial write transactions are accepted and generally handled pursuant to a technique 150 (FIG. 3) in accordance with some embodiments of the invention.

Referring to FIG. 3, according to the technique 150, the controller 70 determines (diamond 152) for a particular incoming partial write transaction whether this transaction conflicts with a transaction that was previously stored in the transaction table 80. A conflict occurs if both transactions target the same memory location. Thus, the controller 70 may determine whether a conflict occurs by examining the entries 82 of the table 80. If the partial write transaction does not conflict with any of the entries 82, then the controller 70 stores a description of the partial write transaction in the transaction table 80, pursuant to block 154.

If, however, the controller 70 determines (diamond 152) that the incoming partial write transaction does conflict with one of the transactions stored in the table 80, then the controller 70 determines (diamond 160) whether the partial write transaction is a match with one of the write combining windows 58, pursuant to diamond 160. If a match has occurred, then the controller 70 records (block 165) the partial write data in the appropriate subwindow 60, pursuant to block 165.

If the controller 70 determines (diamond 160) that the conflicting partial transaction does not match any of the windows 58, then the controller 70 determines pursuant to diamond 168 whether a write combining window 58 is available. If so, the controller 70 records (block 170) the partial write information in a previously unoccupied write combining window 58. Otherwise, the controller 70 generates (block 169) a retry on the front side bus 32 (see FIG. 1).

Due to the long latency of this memory back-fill process, the processor may issue subsequent partial writes within the same cache-line (e.g. premature write combining evictions). The partial-write optimization logic described herein is able to track the partial write transactions in the write combining windows 58 and is able to complete the partial write transactions without retry. In the meantime, partial write data is merged with the back-filled cache-lines. The optimization also provides a “merged data tracking queue” structure to hold on to the merged data entry without the actual write to memory. By holding on the merged line in data-buffer, the data-buffer entries function as a small cache. Any subsequent partial write that is hit to the merged data queue can get the back-filled line immediately without requiring re-accessing memory. When the merged data tracking queue overflows, the cache-line corresponding to the oldest merged data tracking queue entry is evicted (written) to memory.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A bridge comprising:
memory to store a transaction table and write combining windows, each write combining window being associated with a cache line and subdivided into subwindows and each of the subwindows being associated with a partial cache line; and
a controller to:
determine whether an incoming partial write transaction conflicts with a transaction stored in the transaction table;
if a conflict occurs, use the write combining windows to combine the partial write transaction with another partial write transaction if one of the write combining windows is available; and
issue a retry signal to a processor originating the partial write transaction if none of the partial write combining windows are available.

2. The bridge of claim 1, wherein the controller determines whether the partial write transaction matches with a partial write transaction indicated by one of the write combining windows.

3. The bridge of claim 1, wherein the controller stores information about the partial write transaction in the transaction table if a conflict does not occur.

4. The bridge of claim 1, further comprising:
a data buffer to hold data indicative of partial and full write transactions.

5. The bridge of claim 4, further comprising:
logic to merge partial and full write data together.

6. The bridge of claim 1, wherein the processor comprises a microprocessor.

7. The bridge of claim 1, wherein the processor comprises a processing core of a multiple core microprocessor package.

8. A method comprising:
determining whether an incoming partial write transaction conflicts with a transaction stored in a transaction table;
in response to a determination that a conflict occurs, combining the incoming partial write transaction with another partial write transaction if a write combining window is available; and
issuing a retry signal to a processor originating the partial write transaction in response to determining that no write combining window is available.

9. The method of claim 8, further comprising:
determining whether the partial write transaction matches with a partial write transaction indicated by a write combining window.

10. The method of claim 8, further comprising storing data in a data buffer indicative of partial and full write transactions.

11. The method of claim 8, wherein the processor comprises a processing core of a multiple core microprocessor package.
